(19) United States
(12) Patent Application Publication
(10) Pub. No.: US 2008/0090572 A1
(43) Pub. Date: Apr. 17, 2008

(54) INCREASING A SECRET BIT GENERATION RATE IN WIRELESS COMMUNICATION

(75) Inventors: Inhyok Cha, Yardley, PA (US); Yogendra C. Shah, Exton, PA (US); Chunxuan Ye, King of Prussia, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 11/870,770

(22) Filed: Oct. 11, 2007

Related U.S. Application Data
(60) Provisional application No. 60/829,001, filed on Oct. 11, 2006.

(51) Int. Cl. H04Q 7/20

(52) U.S. Cl. 455/436

(57) ABSTRACT

A technique is applied to increase secret bit generation rate for a wireless communication. A wireless transmit/receive unit (WTRU) measures channel impulse responses (CIRs) on downlink and generates secret bits based on the CIRs. Each of the network entities also measures a CIR on uplink between itself and the WTRU. On the network side, the network entities forward the CIRs on uplink to an aggregation controller, which generates secret bits based on the uplink CIRs. Alternatively, in a cooperative network, a cooperating node may measure CIRs on channels with a source node and a destination node and generate secret bits. The cooperating node then sends the secret bits to the destination node so that the secret bits are used for communication between the source and destination nodes. The secret bits are further characterized by a joint randomness not shared with others (JRNSO).

### CROSS REFERENCE TO RELATED APPLICATIONS

This application is a non-provisional of the following U.S. provisional application number which is incorporated by reference as if fully set forth: Ser. No. 60/829,001, filed Oct. 11, 2006.

### FIELD OF INVENTION

The embodiments disclosed relate to wireless communications.

### BACKGROUND

Joint randomness not shared with others (JRNSO) is characteristic of a communication channel exploited by a secret key generation technique being developed to provide ‘perfect’ security over wireless communication networks. A ‘perfectly’ secret key is defined such that the security of the secret key can be rigorously established without any assumption of limits on an eavesdropper's computational power. Data encryption and message authentication (e.g., integrity check) are two particular utilizations of JRNSO. The problem with the direct application of JRNSO to practical security applications is the relatively low rates of secret bit generation achievable in most radio frequency (RF) channels and scenarios. Since data encryption requires a fresh set of key bits for every data transmission burst, the rate of secret bit generation can be the cause for data transmission rate drag, while waiting for the next fresh key bits to become available.

Higher JRNSO bit rates are achievable for channels that are more highly scattered and are faster time-varying. Thus, a mobile phone user moving at high speed within a scatter-rich environment will generate the highest number of secret bits. Unfortunately, in many real scenarios, (e.g., stationary users using his/her mobile phone talking to a base station on a line-of-sight (LOS) channel), both the scattering and the channel variation are poor and consequently the secret bit generation rate is reduced. How to increase the JRNSO bit generation rate is thus a central problem in application of JRNSO in practical wireless communication systems.

### SUMMARY

A method increases a joint randomness not shared by others (JRNSO) secret key bit generation rate. A mobile wireless transmit/receive unit (WTRU) measures channel impulse responses (CIRs) on a wireless communication with another network entity, such as a base station. The WTRU generates JRNSO bits based on the CIRs on received downlink signals and uses the JRNSO bits for communication, such as message authentication or data encryption. Each of the network entities also measures a CIR on their respective uplink signals received from the WTRU. The network entities forward the CIRs on uplink to an aggregation controller. The aggregation controller then generates JRNSO bits based on the uplink CIRs. The aggregation controller, such as a radio network controller (RNC), intentionally induces a hard or soft handover of the WTRU to each of several network entities to increase the JRNSO bit generation rate, particularly if any of the network entities has formed a channel link with the WTRU with properties that are conducive to joint randomness (e.g., significant scattering and fast time variations).

Another related method is applied in a cooperative network, wherein a cooperating node may measure CIRs on channels with a source and one destination node, and generate an aggregated set of secret bits (i.e., a secret key). The cooperating node sends the secret bits to the destination node, so that the secret bits are used for encrypted communication between the source and destination node.

### BRIEF DESCRIPTION OF THE DRAWINGS

A more detailed understanding of the embodiments may be had from the following description, given by way of example, and to be understood in conjunction with the accompanying drawings, wherein:

FIG. 1 is an illustration of generation of JRNSO bits using multiple base stations in accordance with a first embodiment;

FIG. 2 shows a signaling diagram for generating JRNSO bits for a hard handover in accordance the first embodiment;

FIG. 3 shows signaling diagram for generating JRNSO bits using soft handover in accordance the first embodiment;

FIG. 4 shows generation of JRNSO bits in a simple cooperative network in accordance with the second embodiment.

### DETAILED DESCRIPTION

When referred to hereafter, the terminology wireless transmit/receive unit (WTRU) includes but is not limited to a user equipment, a wireless transmit/receive unit (WTRU), a mobile station, a fixed or mobile subscriber unit, a pager, or any other type of device capable of operating in a wireless environment. When referred to hereafter, the terminology “base station” (BS) or “Node B” includes but is not limited to a site controller, an access point or any other type of interfacing device in a wireless environment.

A method is disclosed which does not require the use of smart antenna on the WTRU, but puts the burden of providing more ‘channels’ to the wireless network, (i.e., by use of multiple wireless nodes, (e.g., base stations), serving the same WTRU). A first embodiment described herein is applicable to a centralized wireless network, such as third generation (3G) cellular networks, (i.e., UMTS, CDMA 2000, etc.), and a second embodiment is applicable to a decentralized cooperative network, (such as an ad hoc network).

In a wireless network, a single WTRU communicates with multiple wireless network nodes, (e.g., multiple Node Bs or other network entities), with an ultimate objective of communicating with a single destination network node. The WTRU can utilize the observed characteristics of the multiple RF channels that it encounters with the multiple wireless nodes in order to construct perfect secrecy bits and use them for encrypted communication with its destination node. Moreover, it is possible for the rate of the generation of the secrecy bits (called “JRNSO bits” or “JRNSO secret bits”) to be higher when communicating with multiple nodes than in the case where the WTRU communicated with only a single wireless node, (either the ultimate destination node or an interim relaying node).

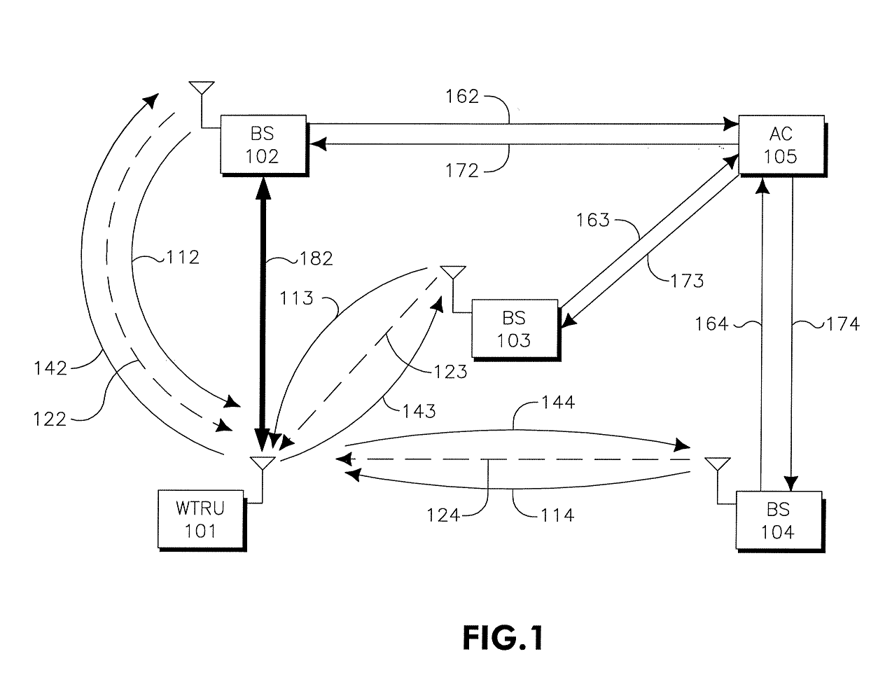

In a first embodiment illustrated in FIG. 1, a WTRU 101 is located in a centralized network, (e.g., cellular network) and communicates with multiple wireless nodes, shown here as base stations 102, 103 and 104. Such a communication configuration is applicable to handover (HO) in cellular communication networks, where WTRU 101 is mobile and is seeking the best candidate target base station (i.e., a new serving base station) while traveling out of range from a currently serving base station. Broadly categorized, there are two types of handovers: soft-handover and hard-handover. In a soft-handover, the communication between WTRU 101 and base stations 102, 103, and 104 takes place concurrently (also known as “make-before-break”). For a hard-handover, WTRU 101 communicates with only one base station (e.g., base station 102, 103 or 104) at any given time before shifting communication sequentially to another base station.

Since base stations are typically fairly distant amongst themselves (typically at least 100s of meters away even in very densely provisioned pico-nets), the RF channels experienced by WTRU 101 for the paths coming from the different base stations 102, 103, 104 will in general be highly uncorrelated and the channel estimates, (i.e., channel impulse responses (CIR)), of the RF channels would be distinct. JRNSO bits are generated from the channel estimates and the generation of the combined channel estimates will lead to additive increase in the number of JRNSO secret bits that can be generated, compared to the case where WTRU 101 is served by only one of the base stations 102, 103, 104, (i.e., the serving network entity) assuming that the received energy of the signals from each of the base stations is approximately equal. WTRU 101 sees different and uncorrelated RF channel sets with the different base stations 102, 103, 104, but the messages it receives from, or sends to, the base stations are the same across the participating base stations.

In FIG. 1, WTRU 101 receives the same message information from each of base stations 102, 103 and 104 including, but not limited to, probing signals, common pilot channel signals, or just information-data-carrying signals where the carried information, or message, is the same for all of the received signals. Since the physical RF channels are distinct, each channel has a unique RF channel impulse response (CIR). The WTRU 101 measures the different downlink CIRs 122,123,124 on the channels based on probing signals 112, 113 and 114 respectively transmitted from the base stations 102, 103,104 on downlink. For example, in a CDMA system, WTRU 101 may use a RAKE receiver and collect all the radio path signals from all the participating base stations.

The WTRU 101 forms a combined CIR from the individual CIRs 122, 123, 124 and generates the JRNSO secret bits from the aggregated CIR. The WTRU then may use the JRNSO secret bits for communication application, (e.g., message authentication or data encryption).

The JRNSO secret bits are privacy-amplified and used to make secret keys, which are subsequently used to encrypt the uplink messages. The WTRU 101 generates and sends uplink encrypted messages 142, 143, 144 to the wireless network at base stations 102, 103 and 104.

On the network side, each of the base stations 102, 103 and 104 also measures CIR on their respective unique channel links to WTRU 101, using probing signals 142, 143, 144 transmitted by WTRU 101. Each of the participating base stations 102, 103, 104 can only measure the CIR between itself and WTRU 101, based on the reception of uplink transmissions of the respective probing signal 142, 143, 144 received from WTRU 101.

Base stations 102, 103, 104 send their respective uplink CIR information 162, 163, 164 (e.g., via a wired interface) to an aggregation controller 105, (e.g., a radio network controller (RNC) or an enhanced Node B (e-Node B) that has RNC functionalities and may be co-located with base station functions. Aggregation controller 105 aggregates the different (and uncorrelated) CIR information from base stations 102, 103, 104 and generates the JRNSO secret bits from the aggregated CIRs thus obtained. Some message exchanges between the RNC and WTRU (via a base station) may be needed in generating the common JRNSO secret bits between them. Next, aggregation controller 105 generates, using the JRNSO secret bits, the final encryption keys, and uses these keys to generate encrypted downlink information-carrying messages 172, 173, 174.

At this time, by prompting from either WTRU 101 or aggregation controller 105, the transmission/reception of the probe signals 112, 113, 114, 142, 143, 144, the CIR estimates 122, 123, 124, and subsequent JRNSO bit generation at WTRU 101 can be terminated and normal communication between the WTRU 101 and its serving base station 102 resumes, shown as communication path 182. The information exchange between WTRU 101 and the preferred base station 102 uses the information-carrying messages encrypted with the JRNSO-derived encryption keys in both the uplink and the downlink.

Alternatively, the aggregation controller 105 may simply collect streams of JRNSO bits from each of the base stations 102, 103, 104 that respectively generate its own JRNSO bit stream from its respective uplink CIRs. The aggregation controller 105 then performs privacy-amplification of the aggregated JRNSO bits to form a perfectly secret key to encrypt downlink messages 172, 173, 174. In this case, the bandwidth-consuming communication from the base stations 102, 103, 104 to the aggregation controller 105 that carries the CIR information 162, 163, 164 may be eliminated. For this embodiment, the WTRU 101 receiver and JRNSO signal processor should be able to discern the CIR information respective to each of the different base stations 102, 103, 104, and generate base-station specific JRNSO bits, instead of first compositing the DL CIR and then generating one stream of JRNSO bits.

FIG. 1 does not depict the usual steps needed in the practical implementation of JRNSO secret bit generation, such as quantization, privacy amplification (e.g., by use of one-way hashing), error correcting coding, and the transmission of the parity bits from one communication node to the other side (typically from the WTRU to the base station). However, such steps, (such as quantization and privacy amplification), may be used as described in co-pending and commonly assigned U.S. patent application Ser. No. 11/339,958 filed Jan. 26, 2006, which is incorporated by reference as if fully set forth herein. As for the error correction coding, the WTRU must still send the error correcting bits at some point before the JRNSO bits can be synchronized at the RNC (or the aggregation controller) side. However, the error control bits do not have to be received by all of the base stations 102, 103, 104, (i.e., WTRU 101 needs only to send the correction bits to only one of the base stations), which then can transfer these bits to the aggregation controller 105 so that it could use those bits in finally synchronizing the JRNSO bits generated on its end.

The first embodiment has been described above in reference to an example of joint randomness introduced by the RF channels and the uniqueness provided by transmit and receiver antenna and RF circuitry for each pair of transceivers. However, other possible sources of joint randomness relate to the modulated carriage of the message information in both the uplink and the downlink by choice of various other channelization attributes, such as channelization and scrambling codes and their offsets (in the case of CDMA-based systems), choice of frequency-domain sub-carriers (in the case of OFDMA systems), time slots (in the case of TDMA-based systems), and any combinations of these and other channelization attributes. To this end, the probing signals 112, 113, 114, 142, 143, 144 could simply be any known signal or part of a known signal that can be easily used for channel estimation. In the case of frequency division duplex (FDD) WCDMA systems, for example, such a priori known signals as the DL Common Pilot Channel (DL-CPICH) could serve as a probing signal in the downlink. In the uplink also, any known signal or part of a known signal could serve similar purposes.

An alternate method is to use the above technique by a future evolution of WLAN or WiMax networks where several Access Points may cooperate in terms of transmitting and receiving the same message and sending the CIR information to an aggregation controller that collects the CIR information and generates the secret bits.

Additionally, a combination of channelization attributes (such as time slots, transmit timing, frequency slots, code choices, etc) may further be employed to aid WTRU 101 receiver to identify which CIR information corresponds to which transmitting base station, such that, if desired, WTRU 101 could ‘choose’ a select set of the CIR information for a select set of base stations 102, 103, 104, and use only the selected aggregated CIRs for the generation of the JRNSO bits. In this case, the WTRU 101 may need to indicate to the network-side aggregation controller 105 which signals of base stations 102, 103, 104 were selected. This could be done by in-band or out-of-band signaling.

Further, the first embodiment can be extended whereby each of the multiple base stations 102, 103, 104 that participate in the collective JRNSO secret key generation scheme has multiple antennas or multiple smart antennas such as multiple-input multiple-output (MIMO) or beam-forming antennas. An even higher rate of JRNSO bit generation can then be realized by adapting a sequence of transmissions and receptions using varying smart antenna configurations (for transmission and reception) of each of the multiple base stations participating in the scheme.

The wireless network aggregate controller 105 may collect the CIR information 162, 163, 164 from the base stations 102, 103, 104, and then form the JRNSO secret bits and use them, (e.g., for packet-encrypting message information with the JRNSO bits or some keys derived from them by Privacy Amplification techniques), or alternatively send them over to the base stations 102, 103, 104 for other purposes, (e.g., base-station-site encryption of certain desired information data).

Radio link resources (in time, spectrum, and power) can generally be scarce commodities in practical wireless systems. Thus, using multiple base stations 102, 103, 104 to send and receive the information to serve a common WTRU 101 can become wasteful of some of these radio link resources and may hurt the overall communication serving capacity of the radio network. However, this cost is offset by the benefit of increased security due to the increased secret bit generation rate. Furthermore, some mobile users may have the need (and the authorized privilege) to have increased security in their communication by having the increased JRNSO secret bit rates, albeit at the cost of possibly affecting the capacity of the network in this case, in one embodiment, an authorization/billing system permits certain users to request, pay for, and get authorizations for the service to have increased JRNSO secret bit rates and resulting higher security communication by being served by multiple base stations at the same time for its communication.

The embodiment may also be further expanded to include a method whereby handover (hard and/or soft) is intentionally initiated by the network to increase the rate of secret bit generation by commanding the WTRU 101 to communicate with multiple base stations 102, 103, 104 either in a controlled sequence (in the case of hard handover), or in simultaneous, multiple links with different base stations 102, 103, 104 (as in the case of soft handover). For example, suppose that the WTRU 101 is in an area where it can communicate with multiple base stations 102, 103, 104 without significantly impacting either the quality of the call or the network's capacity. Such is a case where WTRU 101 is located in a cell-overlap area. As such, the network may ‘intentionally’ initiate a handover procedure with WTRU 101. In brief, the following steps will be involved in such a scheme.
1) Different secret bits will be generated per the different links WTRU 101 has with the different base stations 102, 103, 104. If WTRU 101 can ‘pre-sort’ the different CIRs associated with the different base stations 102, 103, 104, it can generate statistically independent sets of secrets bits from each of the CIR sets, and then aggregates the secret bit set, thereby increasing the rate of secret bit generation rate in the downlink.
2) At the network side, each of the base stations 102, 103, 104 only have access to measure its respective uplink CIR associated with WTRU 101. However, a central ‘accumulation controller’ (which could be either one of the base stations 102, 103, 104 involved in the handover or, more likely, an RNC) then collects or accumulates all the different sets of secret bits generated at each of the base stations, and then synchronizes them and uses them to generate a longer stream of secret bits from these accumulated secret bits.
Note that a separate set of parity bits may be generated by the WTRU 101 for each channel involved in the handover during a ‘reconciliation phase’. If N channels are involved, then N independent reconciliations would be performed by the accumulation controller using all the parity bits it receives, where these bits are transmitted together but in N distinct fields with each field corresponding to a channel. An alternative is for each of the base stations to perform the reconciliation phase independently, with the WTRU 101, and only transmits the already reconciled secret bits to the aggregator.
3) After enough secret bits are accumulated collectively by the multiple radio links, the network or the accumulator controller controls the participating base stations 102, 103, 104 to terminate the handover and the JRNSO secret bit generation processes, and lets the WTRU 101 communicate normally with one base station (e.g., 102), or with multiple base stations 102, 103, 104 if the network decides the WTRU 101 needs to be in handover for reasons other than increased JRNSO bit generation).

This method applies when each of the multiple base stations that participate in the collective JRNSO secret key generation scheme transmits and receives using multiple antennas such as MIMO or beam-forming antennas. A higher rate of JRNSO bit generation can be realized by adapting a sequence of transmissions and receptions using varying the smart antenna configurations (for transmission and reception) of each of the multiple base stations participating in the scheme.

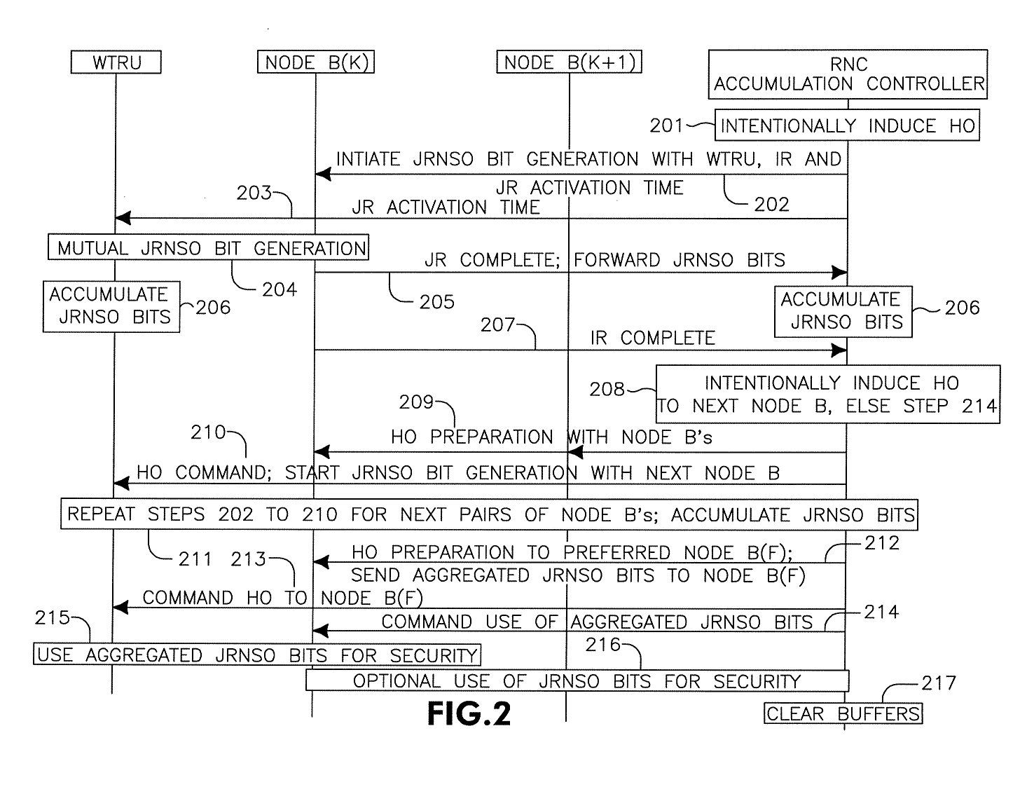

An example flow diagram is depicted in FIG. 2, where Intentionally Induced Hard Handovers of a WTRU with a group of K base stations, depicted as Node B(k) and Node B(k+1) (for k=1 to K), are executed to attain increased number of JRNSO secret bits, processed by an RNC acting as the accumulation controller. From each of the Node Bs in a controlled sequence of communication links with one Node B at a time, the WTRU receives a common signal with a unique RF CIR resulting from the different radio paths associated with the different links. The hard handover/cell reselection method can be repeated until the entity that accumulates the JRNSO bits determines that a sufficiently large number of secret bits have been accumulated. At that time, the intentionally induced hard handover can be terminated and normal communication, possibly using encryption using the previously ‘accumulated’ JRNSO bits, will resume.

In step 201, the RNC decides to start the JRNSO process using intentionally induced handover. At this stage, Node B(k) is the preferred base station, denoted as Node B(F), with which the WTRU communicates. In this example, WTRU and Node B(k) are communicating in CELL_DCH. In step 202, RNC signals Node B(k) to initiate the JRNSO bit generation process with WTRU, while indicating an activation time for information reconciliation (IR), and an activation time to reconcile JRNSO bits with WTRU (i.e., JRNSO reconciliation (JR)). In step 203, RNC signals the activation time for JRNSO bit reconciliation with Node B(k). Following reconciliation, WTRU and Node B(k) communicate in step 204, mutually gathering CIR information and generating JRNSO bits. WTRU stores its JRNSO bits in its JRNSO buffer and the CIR information in a CIR buffer. In this example, step 204 is performed in either CELL_FACH or CELL_DCH. In step 205, Node B(k) sends an indication to RNC that reconciliation of JRNSO bits is completed, and forwards the reconciled JRNSO bits to the RNC.

Alternatively, if the RNC generates the JRNSO bits, then Node B(k) transmits the CIR data associated with the WTRU link, to the accumulation controller RNC in step 204, and the CIR information is stored in a CIR data buffer associated with Node B(k). If no buffer has been set up yet to receive the CIR data from the current base station Node B(k), a new CIR data buffer is established by the RNC for the current base station Node B(k).

In step 206, WTRU accumulates its JRNSO bits in a dedicated buffer for Node B(k), while RNC accumulates the JRNSO bits sent by Node B(k) in a buffer dedicated to Node B(k). Upon completion of information reconciliation (IR), Node B(k) transmits an indication to RNC that acknowledges IR completion in step 207.

In step 208, RNC decides whether to intentionally induce another handover to a next Node B (i.e., Node B(k+1)). If no further handovers are to be induced, the process skips to step 214. Otherwise, at step 209, RNC initiates handover preparation with Node B(k) and Node B(k+1), through a conveyance of signaling and procedures according to UMTS 3GPP standards. In step 210, RNC sends a handover command to WTRU for handover to Node B(k+1) along with an initiation signal for JRNSO bit generation with Node B(k+1). As shown in step 211, the above steps 202 to 210 are repeated for RNC, WTRU, Node B(k+1) and Node B(k+2), and so on, at each cycle incrementing k by one, until all K base stations included in the intentionally induced handover process are exhausted. RNC continues to accumulate in the RNC buffer the network side JRNSO bits sent by each successive base station. In step 212, RNC initiates handover preparation to allow WTRU to handover to the original preferred Node B(F) (i.e., Node B(k) in this example). RNC also sends the aggregated JRNSO bits to Node B(F) to be used in communication with WTRU. Next in step 213, RNC sends a handover command to WTRU for handover to Node B(F). Then RNC signals to Node B(F) to use the aggregated JRNSO bits to communicate with WTRU (step 214).

In step 215, WTRU and Node B(F) communicate using aggregated JRNSO bits for security of the communication link between them. WTRU and Node B(F) may also resume JRNSO bit generation process, in order to generate fresh secret bits. The NodeB(F) and RNC may also communicate using the JRNSO bits for security of the communication between them (step 216), by using the JRNSO bits for such security purposes as message authentication, authorization, and/or data encryption. Finally, WTRU and RNC clear their buffers (step 217) of old JRNSO bits and any old CIR information which had been accumulated as a result of prior JRNSO generation, reconciliation and accumulation. The buffers are flushed out in blocks, after a block of bits are synchronized with the same block of bits that are generated at the corresponding transceiver.

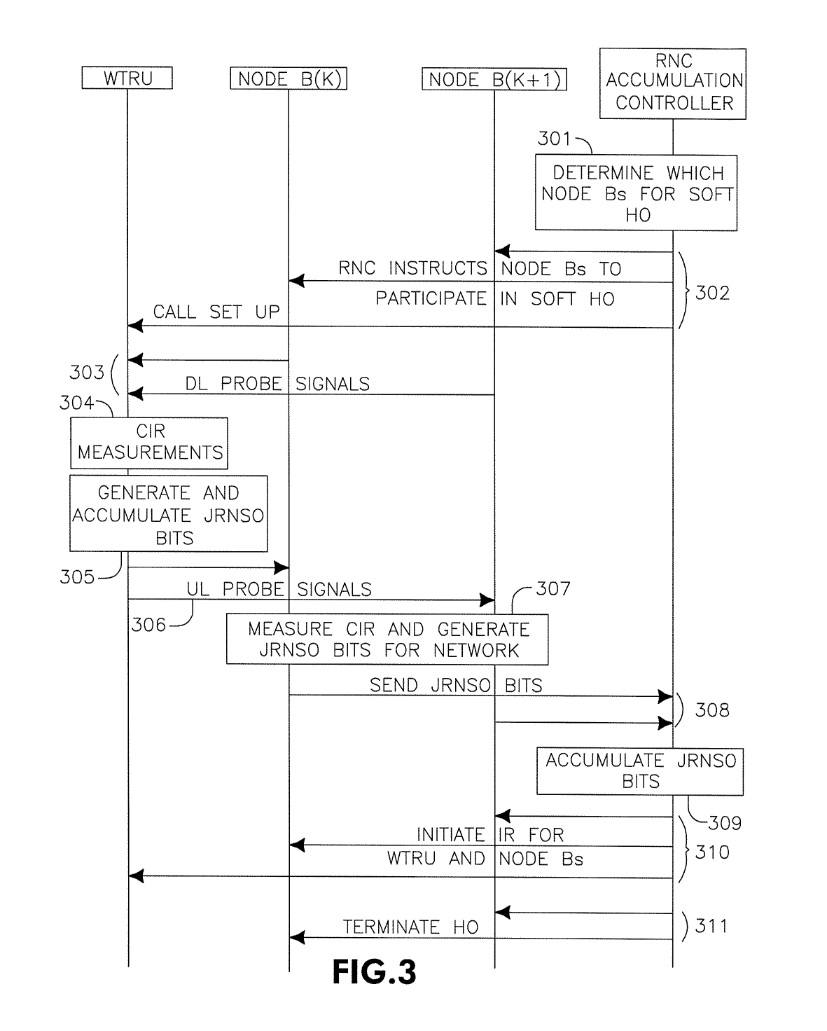

FIG. 3 illustrates a method for an alternative embodiment which uses an intentionally induced soft handover. From each of the Node Bs, the WTRU simultaneously receives a common signal with a unique RF CIR resulting from the different radio paths associated with the different links from the WTRU to the different Node Bs.

As shown in FIG. 3, in step 301, the RNC determines which Node Bs will participate in an intentionally induced soft handover with the WTRU to generate increased number of JRNSO secret bits. Then in step 302, RNC instructs the Node Bs to participate in the soft handover. This message is also sent to the WTRU in a call set-up message. Each of the participating Node Bs in step 303 transmits the same known signal, such as a DL Probe Signal, to the WTRU, using slightly different offsets in transmit timing. In step 304, the WTRU receives the different channel information from the downlink CIR measurements made from the reception of a known downlink signal transmitted from the Node Bs. For example, the WTRU could use a RAKE receiver for this purpose. Then in step 305, the WTRU generates multiple sets of JRNSO secret bits from each of the individual CIRs, and then accumulates the secret bits to form a longer set of secret bits in its buffer. Such accumulation continues until the WTRU is instructed to stop the accumulation procedure by the network side. Simultaneously or near-simultaneously with steps 302-304 above, the WTRU transmits a known uplink signal to the multiple Node Bs participating in the soft handover, such as an uplink probe signal (step 306). Each of the multiple base stations Node B(k) and Node B(k+1) receives the uplink probe signal, and independently derives a unique set of CIR information that is mutually related to the WTRU's CIR information for the respective base station. Each of the base stations Node B(k) and Node B(k+1) then generates JRNSO secret bits (step 307) from its own uplink CIR information. Each of Node B(k) and Node B(k+1) sends its own JRNSO bits to an accumulation controller at the RNC (or alternatively, one or more enhanced Node Bs (eNBs)) in step 308. The accumulation controller then aggregates the different (and uncorrelated) CIR information from Node B(k) and Node B(k+1) and generates a larger set of JRNSO secret bits (step 309). Alternatively, each of the Node Bs generate the JRNSO bits, separately from each other, with the WTRU, and then sends the bits to the RNC where the bits are accumulated. A secrecy reconciliation procedure is initiated by the RNC and sends the command at step 310 to the WTRU and to the participating Node Bs (or one selected Node B, if a single Node B is chosen to receive the Parity bits transmitted by the WTRU for secrecy reconciliation). After it determines that a sufficiently large number of JRNSO secret bits have been generated/accumulated, the RNC instructs the participating Node Bs to terminate the soft handover at step 311. Typically, a single “best” Node B is then selected to resume normal communication. The contents of the subsequent normal communication, however, can now be encrypted using the JRNSO secret bits or keys derived from them.

For the CIR measurement in the downlink, any known signal or part of a known signal that can be easily used for continuous channel estimation would suffice. In the case of FDD WCDMA systems, for example, the downlink Common Pilot Channel (DL-CPICH) could serve as such a known signal used for CIR measurement. In the uplink similarly, a known signal such as the pilot part of an uplink Dedicated Physical Channel (DPCH) could serve the same purpose.

The WTRU as well as the base stations also could have a MIMO and/or smart antenna mechanism on them. In such a case, the intentional handover has to be synchronized with proper switching, configuration, or beam-forming of the antenna elements on the WTRU. For example, in a soft handover situation the WTRU may have to switch its antenna to an ‘omni’ mode, so that it can communicate with many Node Bs simultaneously. For a hard handover situation where the WTRU is equipped with a beam-forming antenna, the beam-forming direction has to be optimized in a sequence, and synchronized with the sequence of each of the Node Bs that participates in the hard handover.

Another embodiment which generates JRNSO bits in a cooperative network will be described hereinafter. The basic concepts of using handover techniques to increase JRNSO bit generation rates as hereinbefore described for a centralized network can be utilized for increasing JRNSO secret bit rates in a de-centralized network.

In the handover methods described above, there are components of aggregation of secret bits. If aggregation of JRNSO bits from different RF paths does not take place, there is no increase of JRNSO bit rates compared to the case where a mobile station uses RF-channel information from only a single RF link with another station or node for the generation of JRNSO secret bits.

Unlike in a centralized network where the sequences and modes of transmission and reception of bits from and to the multiple ‘base stations’, as well as aggregation of the JRNSO bits from each of the RF links can be controlled by a central controlling entity on the network side, there is little such coordination that takes places in a de-centralized network. Such a de-centralized network is commonly called ‘cooperative’ (i.e., a cooperative network). Methods as described hereinbefore can be applied to increase JRNSO bit generation rates.

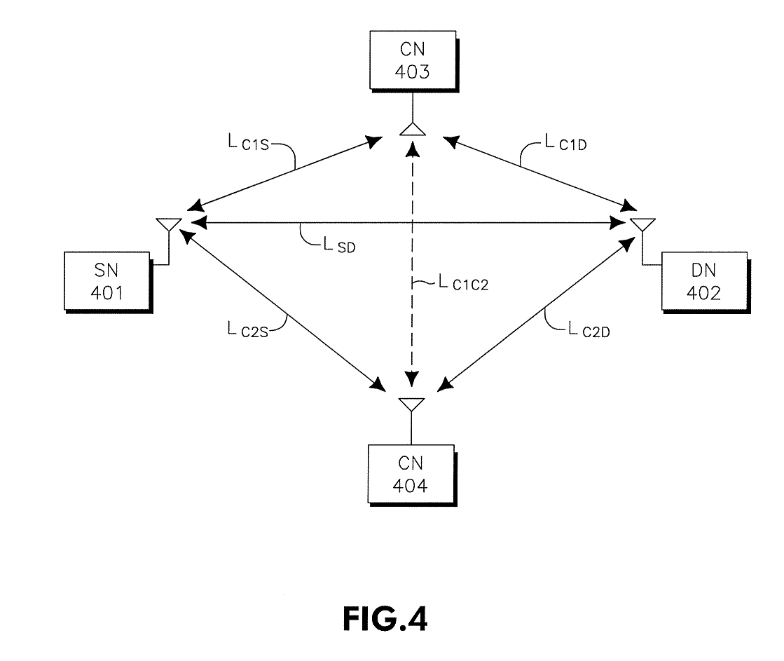

FIG. 4 shows generation of JRNSO bits in a simple cooperative network in accordance with another embodiment. A source node 401 (e.g., a mobile WTRU) wishes to communicate securely with a final destination node 402. Since node 401 may or may not have a wireless communication link Lsd with destination node 402. If it had one, it would be able to generate some JRNSO bits, {Bsd} with a rate of generation Rsd.

Within the decentralized network, there are two other nodes 403 and 404 that act as cooperative nodes for source node 401 and destination node 402. Assume that both nodes 403 and 404 have wireless communication links Lc1s and Lc2s, respectively, with the source node 401, and wireless communication links Lc1d and Lc2d, respectively, with the destination node 402, along with Link Lc1c2 between nodes 403 and 404.

Using point-to-point JRNSO techniques, the first cooperative node 403, communicating with the source node 401, can generate JRNSO bits {Bc1s} with a certain rate Rc1s, and also JRNSO bits {Bc1d} with the destination node 402 with a rate Rc1d. Likewise, the second cooperative node 404 can generate JRNSO bits {Bc2s} with a rate Rc2s with the source node 401. Cooperative node 404 can also generate JRNSO bits {Bc2d} with a rate Rc2d with the destination node 402. Additionally, cooperative nodes 403 and 404 can generate JRNSO bits {Bc1c2} with a rate Rc1c2 between themselves.

It is reasonably assumed that the capacities of each of the communication links Lsd, Lc1s, Lc1d, Lc2s, Lc2d and Lc1c2, are much larger than their respective JRNSO bit generation rates Rsd, Rc1s, Rc1d, Rc2s, Rc2d and Rc1c2.

The cooperative node 403 can encrypt the JRNSO bits it generated with source node 401, with rate Rc1d, using the JRNSO bits it generated with the destination node 402. For example, this encrypting can be done using one-time padding. Thus, it can convey, at the rate of min(Rc1s, Rc1d), all (if Rc1d>=Rc1s) or part (if Rc1d<Rc1s) of the secret bits {Bc1s} to the destination node 402, on behalf of the source node 401. Likewise, the cooperative node 404 can convey, at the rate of min(Rc2s, Rc2d), all (if Rc2d>=Rc2s) or part (if Rc2d<Rc2s) of the secret bits {Bc2s} to the destination node 402, on behalf of the source node 401. Additionally, the link Lc1c2 (with JRNSO bit generation rate of Rc1c2), between the two cooperative node, can also be used to convey all or parts of the source-to-cooperative-node JRNSO bits {Bc1s} and/or B{c2s}.

As an example, consider the following case. Here, it is assumed that the path using cooperative node 403 (i.e., links Lc1d and Lc1s) yields a bit generation rate comparison of Rc1d>=Rc1s, so that all of bits {Bc1s} can be securely transported to destination node 402 using just the link Lc1d. On the other hand, it is assumed that bit generation rate comparison related to cooperative node 404 (i.e., for links Lc2d and Lc2s) yields Rc2d<Rc2s, so that not all of bits {Bc2s} can be securely transported using just the link Lc2d. Note, however, if the link Lc1c2 between the cooperative nodes has a non-zero JRNSO bit capacity (Rc1c2>0), then this link Lc1c2 and its JRNSO capacity combined with the ‘excess capacity’ that the link Lc2d has over Lc1s, can be used to encrypt (e.g., using one-time padding) and convey ‘Additional’ or ‘residual’ bits to the destination node 402, which could be either all or a part of bit set {Bc2s}. Let JRNSO rate Rc1d be defined as follows:

Rc1d=Rc1s+delRc1s Equation 1

where ‘delRc1s’ is the ‘excess’ JRNSO capacity that the link Lc1d has, over the ‘source’ capacity of the link Lc1s. Then the cooperative node 403 can use the excess capacity delRc1s in order to encrypt (using one-time padding) and convey either the entirety or a part of the bits {Bc2s}, if those bits had been transported from node 404 using the link Lc1c2, which has its own secret-bit capacity Rc1cs. For example, all of {Bc1s} as well as {Bc2s} can be transported securely to the destination node 402 if the following conditions are met:

Rc1c2≧(Rc2s−Rc2d) Equation 2

delRc1s≧(Rc2s−Rc2d )>0 Equation 3

In Equations 1, 2 and 3 above, ‘perfect security’ of the transported JRNSO bits (i.e., all or part of {Bc1s} and all or part of {Bc2s}), is preserved, because they are protected by the ‘onetime-pad’ encryption by the additional JRNSO bits {Bc1d} between the destination node 402 and the cooperative node 403, the JRNSO bits {Bc2d} between the destination node 402 and the cooperative node 404, and JRNSO bits {Bc1c2} between cooperative nodes 403 and 404, respectively. Note that perfectly secure transport of all of the bits {Bc1s} and {Bc2s} is dependent upon the capacities of the links Lc1d, L2d and Lc1c2. Even if these conditions are not met, however, perfectly secure transport of at least a part of the JRNSO bits is still possible, although their rates will be limited.

Additionally, by way of Equations 1 to 3 above, both the source node 401 and the destination node 402 can have the same ‘secret’ bits, which are an ‘aggregation’ of the transported secret bits (i.e., all or a part of {Bc1s}+all or a part of {Bc2s}). The source node 401 knows these bits because it has generated these bits with the two cooperative nodes 403, 404. The destination node 402 knows these bits because they were conveyed to them from the two cooperative nodes 403, 404 using onetime-pad encryption.

If the source node 401 and the destination node 402 also had a wireless link of their own, they could generate JRNSO bits {Bsd} at the rate of Rsd. This would be the point-to-point, or source-to-destination generation of JRNSO bits.

Upon performing the bit generation procedures described above, the total JRNSO bits that can be aggregated and used for further secret communication between the source node 401 and the destination node 402, will be {Bsd}+all or a part of {Bc1s}+all or a part of {Bc2s}, and the maximum rate of JRNSO bit generation achieved is as follows:

$${R}_{NEW} = \{ \begin{matrix}\begin{matrix}\begin{matrix}{R}_{sd} + min ( {R}_{c 1 s} , {R}_{c 1 d} ) + min ( {R}_{c 2 s} , {R}_{c 2 d} ) , \\ if {R}_{c 1 c 2} = 0 , or , if {R}_{c 1 s} > {R}_{c 1 d} AND {R}_{c 2 s} > {R}_{c 2 d} ,\end{matrix} \\ or , if {R}_{c 1 s} <= {R}_{c 1 d} AND {R}_{c 2 s} <= {R}_{c 2 d}\end{matrix} \\ \begin{matrix}{R}_{sd} + min ( {R}_{c 2 s} , {R}_{c 2 d} ) + min ( {R}_{c 2 s} , {R}_{c 2 d} ) + min ( {R}_{c 2 d} - {R}_{c 2 s} , {R}_{c 1 c 2} , {R}_{c 1 s} - {R}_{c 1 d} ) , \\ if {R}_{c 1 c 2} > 0 AND {R}_{c 2 s} < {R}_{c 2 d} but {R}_{c 1 s} > {R}_{c 1 d}\end{matrix} \\ \begin{matrix}{R}_{sd} + min ( {R}_{c 1 s} , {R}_{c 1 d} ) + min ( {R}_{c 2 s} , {R}_{c 2 d} ) + min ( {R}_{c 1 d} - {R}_{c 1 s} , {R}_{c 1 c 2} , {R}_{c 2 s} - {R}_{c 2 d} ) , \\ if {R}_{c 1 c 2} > 0 AND {R}_{c 1 s} < {R}_{c 1 d} but {R}_{c 2 s} > {R}_{c 2 d}\end{matrix}\end{matrix} \qquad Equation 4$$

The above equation can be further simplified to the following:

$${R}_{NEW} = {R}_{sd} + min ( \begin{matrix}\begin{matrix}\begin{matrix}{R}_{c 1 d} + {R}_{c 2 d} , \\ {R}_{c 1 s} + {R}_{c 2 s} ,\end{matrix} \\ {R}_{c 1 s} + {R}_{c 1 c 2} + {R}_{c 2 d} ,\end{matrix} \\ {R}_{c 2 s} + {R}_{c 1 c 2} + {R}_{c 1 d}\end{matrix} ) \qquad Equation 5$$

Since all of the 2^{nd}, 3^{rd} and 4^{th} terms in Equation 4 are non-zero or positive, it follows that:

R_{NEW}≧R_{sd} Equation 6

### Thus, in the cooperative network one can achieve JRNSO bit generation rates larger than the one achievable with only the original, source-to-destination radio link.

If the capacity of any of the radio links is above a desired amount, then the node could conduct ‘normal’ or ‘data-carrying’ communication with the other node for its own purpose other than passing all or a part of the JRNSO bits.

Additionally, according to the above analysis, only one cooperative node, say node 403, is needed to increase the JRNSO bit rate compared to the single, source-to-destination link case. The above example illustrates the two cooperative nodes only as an example to show that, when one has N such cooperative nodes, one could possibly increase the ‘aggregated’ JRNSO bit rate by the contributions from the N cooperative nodes.

A general cooperative network with m nodes (C₁, . . . ,Cₘ) is next considered, where C₁ is the source node, Cₘ is the destination node, and C₂, . . . , Cₘ₋₁ are the cooperative nodes. Suppose any pair of nodes Cᵢ, Cⱼ generate a JRNSO secret key K_{i,j} (or equivalently K_{j,i}), where i and j denote first and second node ordinals for a node pair, and 1≦i≠j≦m. Then, K_{i,j} is independent of K_{i′,j′}, where (i,j)≠(i′, j′). Without loss of generality, it is assumed that every pair-wise secret key K_{i,j} being a full entropy bit string, according to the following:

H(K_{i,j})≈|K_{i,j}|, Equation 7

where |.| denotes the length of a bit string. With the help of cooperative nodes, a source node C₁ and a destination node Cₘ wish to generate a longer secret key K than K_{l,m}. Note that the secret key length is equivalent to the rate of generating a secret key in fixed time duration. Next, it is shown that the maximum length of a secret key K that can be generated by the source node and the destination node in this general cooperative network. This problem is well modeled by a weighted undirected graph. Each pair-wise secret key is an edge connecting the corresponding nodes. The weight of an edge is equal to the length of the corresponding pair-wise secret key, which is always a positive integer. If a pair of nodes does not share a secret key (equivalently its secret key length is zero), then no edge exists between this pair of nodes.

Let G=(N,E) be a graph representing a general cooperative network, where the node set N=(C₁, . . . ,Cₘ). A cut on the graph G=(N,E) is a partition of the nodes into two sets N₁, N₂, such that the source node C₁∈N₁ and the destination node Cₘ∈N₂. Any edge (Cᵢ, Cⱼ)∈E with Cᵢ∈N₁ and Cⱼ∈N₂ is said to be a cut edge. In weighted graphs, the size of a cut is defined to be the sum of the weights of its edges. A cut is minimal if the size of the cut is not larger than the size of any other cut.

The following description demonstrates that the maximum length of a secret key that can be generated between the source node and the destination node in a general cooperative network is equal to the weight of the minimal cut on the weighted graph representing this general cooperative network.

The maximum length of a secret key in a general cooperative network is given by the following:

$$\begin{matrix}H ( {⋃}_{i , j ∈ \{ 1 , … , m \}} {K}_{i , j} ) - {min}_{( {R}_{1} , … , {R}_{m} ) ∈ π} {\sum }_{i = 1}^{m} {R}_{i} , & Equation 8 \\ where & \\ π = \{ \begin{matrix}( {R}_{1} , … , {R}_{m} ) \text{:} {\sum }_{i ∈ B} {R}_{i} \geq H ( {⋃}_{j or l ∈ B} {K}_{j , l} \vert {⋃}_{j or l ∉ B} {K}_{j , l} ) , \\ B ⋐ \{ 1 , … , m \} , \{ 1 , m \} ⊄ B .\end{matrix} \} & Equation 9\end{matrix}$$

Although the single-letter characterizations of the maximum length are given by Equations 8 and 9, the computation of the length involves linear programming, which is not so intuitive.

However, a simple upper bound on the maximum length can be derived from Equations 8 and 9. Specifically, the maximum length is upper bounded by:

$${min}_{all cuts B = ( {B}_{1} , {B}_{2} )} H ( {⋃}_{i or j ∈ {B}_{1}} {K}_{i , j} ) + H ( {⋃}_{i or j ∈ {B}_{2}} {K}_{i , j} ) - H ( {⋃}_{i , j ∈ \{ 1 , … , m \}} {K}_{i , j} ) . \qquad Equation 10$$

Note that the sum of three entropies in Equation 10 corresponds to the weight of a cut B=(B₁,B₂) on the graph, where B₁ and B₂ are two node sets separated by the cut. Hence, the maximum length is no more than the weight of the minimal cut on the graph.

In the graph representing a general cooperative network, a node can securely send n information bits (by means of one-time pad) to its neighbor node if the weight of the edge connecting these two nodes is at least n. The weight of an edge in the graph can be considered as the capacity of a secure communication channel. Hence, the maximum length of the secret key that can be generated by the source node and the destination node is no less than the maximal flow from the source node to the destination node. Because the maximal flow in a graph equals the weight of the minimal cut on the graph, the maximum length is no less than the weight of the minimal cut on the graph. Accordingly, the maximum length is equal to the weight of the minimal cut on the graph, which is equal to the maximal flow of the graph.

Returning to the example illustrated in FIG. 4, the cooperative network represented by a weighted graph can be further illustrated. For the network shown in FIG. 4, all four possible cuts and their corresponding weights in the graph representing the cooperative network are shown below:

{(S),(C₁,C₂,D)} R_{sd}+R_{sc}_{₁}+R_{sc}_{₂} 1)

{(S,C₁),(C₂,D)} R_{sd}+R_{sc}_{₂}+R_{c}_{₁}_{c}_{₂}+R_{c}_{₁}_{d} 2)

{(S,C₂),(C₁,D)} R_{sd}+R_{sc}_{₁}+R_{c}_{₁}_{c}_{₂}+R_{c}_{₂}_{d} 3)

{(S,C₁,C₂),(D)} R_{sd}+R_{c}_{₁}_{d}+R_{c}_{₂}_{d} 4)

where S represents source node 401, C1 and C2 respectively represent cooperative nodes 403, 404, and D represents destination node 402. Note that Equation 5 is the minimum of the four expressions above.

For this embodiment which applies a cooperative network, the following labeling procedure is used to determine the maximum flow/minimum cut, using the above referenced graph G=(N,E) representing the node set N=(C₁, . . . ,Cₘ).
1) Scan node C₁ and label nodes that can be reached with additional flow.
2) Choose the node Cᵢ that was labeled earliest but is not yet scanned. For each edge from Cᵢ to an unlabeled node Cⱼ, determine whether the required flow x_{i,j} is less than the edge weight w_{i,j}. If so, label node Cⱼ with(Cᵢ,dⱼ), where the positive number dⱼ is the additional flow that can reach Cⱼ through Cᵢ:

dⱼ=min{dᵢ,w_{i,j}−x_{i,j}}
3) If the destination receives a label, increase the flow and return to step 1. If the destination is not yet labeled, return to step 2. If all labeled nodes have been scanned without reaching the destination, then the procedure ends.

Alternatively, other graph theory procedures other than the above labeling procedure which achieve the maximum flow, can be used to generate a secret key with the largest key length.

The above description addressed embodiments for generating a secret key between a source node and a destination node. One extension to these embodiments is that a secret key may be generated by several nodes, with the help of other cooperative nodes.

Another extension is a case where more than one pair of nodes wishes to generate pair-wise secret keys. In this case, there is a balance between the sizes of the generated secret keys due to the network capacity. In other words, the generation of a pair wise long secret key may result in other shorter secret keys, because the generation of the long secret key may use a large proportion of the network resources, limiting the generation of other secret keys.

There are some practical issues that may need to be considered when using cooperative nodes to increase the JRNSO bit rates between a source and a destination node, such as trustworthiness of the cooperative nodes that participate and aid the source and the destination to increase the JRNSO bit rates. The cooperative nodes are considered completely trustworthy if they are trusted not to divulge the JRNSO bits they convey from the source to the destination. A cooperative node, say node 403 in the above example, could have compromised software and might reveal to an eavesdropper or other external entities the secret bits {Bc1s} it has to convey to the destination node 402. Such revelations may take place unbeknownst to the source node and destination node, and even to the cooperative node itself. One way to possibly ascertain the trustworthiness of the cooperative nodes before they are allowed to be engaged in the JRNSO bit aggregation procedure, may be to use techniques from the Trusted Computing Group (TCG), i.e., a cooperative node would only be allowed to participate in the JRNSO bit aggregation when it can remotely attest its ‘trustworthiness’ or ‘platform integrity’ to both the source and the destination nodes.

Although the features and elements of the embodiments are described in particular combinations, each feature or element can be used alone without the other features and elements of the embodiments or in various combinations with or without other features and elements of the embodiments. The methods or flow charts provided may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for increasing a secret bit generation rate in a wireless communication, comprising:
measuring channel impulse responses (CIRs) on a communication signal received by a wireless transmit/receive unit (WTRU) from a plurality of network entities;
generating perfectly secret bits based on the measured CIRs; and
performing at least one handover from a serving network entity to a target network entity.

2. The method as in claim 1 wherein the communication signal received by the WTRU is a probing signal common to all of the network entities.

3. The method as in claim 2, wherein the probing signal includes at least one of a common pilot channel signal and an information-carrying message with identical information received from each of the plurality of network entities.

4. The method as in claim 1 wherein the handover is a hard handover, further comprising:
receiving an activation time to reconcile the perfectly secret bits with the serving network entity;
accumulating the perfectly secret bits in a buffer dedicated to the serving network entity; and
communicating with the serving network entity using an aggregated key of perfectly secret bits.

5. The method as in claim 1 wherein the handover is a soft handover, wherein the CIR measurements are performed simultaneously on received downlink probing signals from the plurality of network entities, from which unique sets of CIR information are derived respectively for each network entity, further comprising:
sending uplink probe signals to the plurality of network entities to allow the network entities to independently derive CIR information that is mutually related to the unique sets of CIR information derived by the WTRU.

6. The method as in claim 5, wherein the uplink probe signal is a pilot part of an uplink Dedicated Physical Channel (DPCH).

7. A method for increasing a secret bit generation rate in a wireless communication, comprising:
measuring channel impulse responses (CIRs) on radio path signals received by a wireless transmit/receive unit (WTRU) from a plurality of network entities;
discerning an individual CIR received by each network entity using a combination of channelization attributes; and
generating perfectly secret bits based on the measured CIRs.

8. The method as in claim 7, wherein the WTRU uses a RAKE receiver for receiving the radio path signals from all the network entities.

9. The method as in claim 8, further comprising forming an aggregated CIR from the individual CIRs, whereby the perfectly secret bits are generated from the aggregated CIR.

10. The method as in claim 7, wherein the channelization attributes include at least one of channelization and scrambling codes and their offsets, choice of frequency-domain sub-carriers, and time slots.

11. The method as in claim 7, further comprising the WTRU selecting a set of CIRs for a selected set of network entities, and the WTRU using the selected set of CIRs for generation of the perfectly secret bits.

12. The method as in claim 7 wherein the WTRU includes multiple antennas, further comprising generating the perfectly secret bits by adapting a sequence of transmissions and receptions using varying antenna configurations.

13. A method for increasing a secret bit generation rate in a wireless communication network that includes a plurality of communication nodes, comprising:
a cooperating node measuring channel impulse responses (CIRs) on channels with a source node and a destination node;
the cooperating node generating first secret bits based on the CIR on a channel with the source node and second secret bits based on the CIR on a channel with the destination node; and
the cooperating node sending the first secret bits to the destination node.

14. The method as in claim 13, further comprising:
the source node and the destination node measuring a CIR on a channel between the source node and the destination node; and
the source node and the destination node generating third secret bits based on the CIR on a channel between the source node and the destination node.

15. The method as in claim 13, further comprising:
a first cooperating node measuring channel impulse responses (CIRs) on channels with a source node and a destination node, and generates first secret bits based on the CIR on a channel with the source node and second secret bits based on the CIR on a channel with the destination node; and
a second cooperating node measuring channel impulse responses (CIRs) on channels with a source node and a destination node and generates first secret bits based on the CIR on a channel with the source node and second secret bits based on the CIR on a channel with the destination node,
whereby the first and second cooperating nodes send the first secret bits to the destination node, respectively.

16. The method as in claim 15 wherein the first secret bits generated by the first cooperating node is forwarded to the destination node via the second cooperating node.

17. The method as in claim 13, further comprising:
generating a perfectly secret key between the source node and the destination node based on the first and second secret bits.

18. The method as in claim 17, wherein the perfectly secret key is generated by several nodes.

19. The method as in claim 13, further comprising performing trustworthiness verification of the cooperating node by using a trusted computing group (TCG) based procedure.

20. A wireless transmit/receive unit (WTRU) comprising a processor configured to measure channel impulse responses (CIRs) on a communication signal received from a plurality of network entities; generate perfectly secret bits based on the measured CIRs; and perform at least one handover from a serving network entity to a target network entity.

21. The WTRU as in claim 20 wherein the communication signal received by the WTRU is a probing signal common to all of the network entities.

22. The WTRU as in claim 21, wherein the probing signal includes at least one of a common pilot channel signal and an information-carrying message with identical information received from each of the plurality of network entities.

23. The WTRU as in claim 20 wherein the handover is a hard handover, and the processor is configured to receive an activation time to reconcile the perfectly secret bits with the serving network entity, further comprising a buffer dedicated to the serving network entity and configured to accumulate the perfectly secret bits; whereby the WTRU communicates with the serving network entity using an aggregated key of perfectly secret bits.

24. The WTRU as in claim 20 wherein the handover is a soft handover, and the processor is configured to perform the CIR measurements simultaneously on received downlink probing signals from the plurality of network entities, from which unique sets of CIR information are derived respectively for each network entity; and to send uplink probe signals to the plurality of network entities to allow the network entities to independently derive CIR information that is mutually related to the unique sets of CIR information derived by the WTRU.

25. The WTRU as in claim 24, wherein the uplink probe signal is a pilot part of an uplink Dedicated Physical Channel (DPCH).

26. A WTRU, comprising:
a processor configured to measure channel impulse responses (CIRs) on radio path signals received by a wireless transmit/receive unit (WTRU) from a plurality of network entities; to discern an individual CIR received by each network entity using a combination of channelization attributes; and to generate perfectly secret bits based on the measured CIRs.

27. The WTRU as in claim 26, further comprising a RAKE receiver for receiving the radio path signals from all the network entities.

28. The WTRU as in claim 27, wherein the processor is configured to form an aggregated CIR from the individual CIRs, whereby the perfectly secret bits are generated from the aggregated CIR.

29. The WTRU as in claim 26, wherein the channelization attributes include at least one of channelization and scrambling codes and their offsets, choice of frequency-domain sub-carriers, and time slots.

30. The WTRU as in claim 26, wherein the processor is configured to select a set of CIRs for a selected set of network entities, and the processor uses the selected set of CIRs for generation of the perfectly secret bits.

31. The WTRU as in claim 26, further comprising multiple antennas, wherein the processor is configured to generate the perfectly secret bits by adapting a sequence of transmissions and receptions according to varying antenna configurations.

32. A method for increasing a secret bit generation rate in a wireless communication network that includes a plurality of communication nodes, comprising:
N communication nodes measuring CIRs on channels formed by pairs of communication nodes;
pairs of communication nodes generating secret bits based on the measured CIRs on the channel between them; and
a source node and a destination node generating a perfectly secret key.

33. The method as in claim 32, further comprising determining a largest possible perfectly secret key length.

34. The method as in claim 33, further comprising using a weighted graph representation of the N communication nodes to determine the largest possible secret key length.

35. The method as in claim 32, further comprising using a labeling procedure for processing a weighted graph representation of the N communications nodes to generate the perfectly secret key.

36. The method as in claim 32, further comprising using a graph theory algorithm to determine a maximum flow for at least one branch of a weighted graph representation of the N communication nodes to generate a perfectly secret key having a largest possible key length.
